(19) United States
(12) Patent Application Publication
(10) Pub. No.: US 2009/0188097 A1
(43) Pub. Date: Jul. 30, 2009

(54) METHOD OF LAYERED FABRICATION

(75) Inventor: Gerald J. Bruck, Oviedo, FL (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS POWER GENERATION, INC., Orlando, FL (US)

(21) Appl. No.: 12/019,900

(22) Filed: Jan. 25, 2008

(51) Int. Cl. B23P 11/00

(52) U.S. Cl. 29/428; 29/447; 29/445

(57) ABSTRACT

A method of creating a complex three-dimensional object by assembling a plurality of prefabricated elements in a predetermined arrangement and coupling the elements together into an integral three-dimensional object is disclosed.

This invention was made with U.S. Government support under Contract Number DE-FC26-03NT41891 awarded by the U.S. Department of Energy. The U.S. Government has certain rights to this invention.

### FIELD OF THE INVENTION

The present invention relates to a method of constructing a three dimensional object, and more particularly, a method of constructing complex three dimensional objects by assembling a plurality of prefabricated elements, in a predetermined arrangement and coupling the elements together into an integral three-dimensional object.

### BACKGROUND OF THE INVENTION

Multiple methods have been developed for creating three-dimensional metallic components having complex geometric shapes. For example, casting is generally employed to make large numbers of parts where the volume justifies the tooling cost. Casting is limited to relatively thick walled structures, components that can accommodate the required gating and components having relatively course details. Where the cost and long development time of casting tooling cannot be justified, electro discharge machining (EDM) may be used to create limited numbers of parts from solid work pieces. EDM is generally limited to linear machining cuts and to straight line excavations, requires costly tooling and is relatively slow compared to conventional machining methods.

More intricate processing is possible using the laser engineered net shape (LENS) process. The LENS process uses a computer controlled laser beam and powder feeder to create structures by laser fusing the powder in layers. The LENS process is relatively slow and costly, and is, therefore, usually limited to the fabrication of prototypes and small numbers of production parts.

U.S. Pat. No. 4,752,352 to Feygin discloses a method and computer controlled apparatus for forming a laminated integral three-dimensional metal object by stacking layers of material having the same or gradually varying shapes. The layers are subsequently bonded together into an integral metal object.

### SUMMARY OF THE INVENTION

In accordance with a first aspect of the present invention, a method of forming a three-dimensional metal object is provided. The method may comprise providing one or more first prefabricated metal elements having shapes corresponding to one or more first portions of the three-dimensional metal object. One first prefabricated metal element may have a first material property comprising one of a first anisotropic material property and a first coefficient of thermal expansion. The method may further comprise providing one or more second prefabricated metal elements having shapes corresponding to one or more second portions of the three-dimensional metal object. One second prefabricated metal element may have a second material property different from the first material property comprising one of a second anisotropic material property and a second coefficient of thermal expansion. The method may yet further comprise assembling the one or more first prefabricated metal elements and the one or more second prefabricated metal elements in a predetermined arrangement and coupling together the one or more first prefabricated metal elements and the one or more second prefabricated metal elements so as to define the three-dimensional metal object.

In accordance with a second aspect of the present invention, another method of forming a three-dimensional metal object is provided. The method may comprise providing a plurality of prefabricated metal elements having shapes corresponding to adjacent portions of the three-dimensional metal object. At least one of the plurality of prefabricated metal objects may have at least one preformed non-planar surface. The method may further comprise assembling the plurality of prefabricated metal elements in a predetermined arrangement and coupling together the plurality of prefabricated metal elements so as to define the three-dimensional metal object. At least one preformed non-planar surface of at least one of the plurality of prefabricated metal elements may define at least one corresponding non-planar surface of the three-dimensional metal object.

In accordance with a third aspect of the present invention, another method of forming a three-dimensional metal object is provided. The method may comprise providing a plurality of prefabricated metal elements having shapes corresponding to adjacent portions of the three-dimensional metal object. At least one of the plurality of prefabricated metal elements may have at least one interlocking feature cooperating with at least one corresponding interlocking feature of at least one other of the plurality of prefabricated metal elements. The method may further comprise assembling the plurality of prefabricated metal elements in a predetermined arrangement, wherein the interlocking feature of one of the plurality of prefabricated metal elements cooperates with one corresponding interlocking feature of another adjacent prefabricated metal element so as to interlock one an another of the prefabricated metal elements together.

### BRIEF DESCRIPTION OF THE DRAWINGS

While the specification concludes with claims particularly pointing out and distinctly claiming the present invention, it is believed that the present invention will be better understood from the following description in conjunction with the accompanying Drawing Figures, in which like reference numerals identify like elements, and wherein:

FIG. 1 is a diagrammatic view of a three-dimensional metal object formed in accordance with an aspect of the present invention shown in top view;

FIG. 1A is a diagrammatic view of the three-dimensional metal object of FIG. 1 formed by an aspect of the present invention shown in front view;

FIG. 2 is a diagrammatic front view of a three-dimensional metal object formed in accordance with another aspect of the present invention;

FIG. 3 is a diagrammatic view of the three-dimensional metal object of FIGS. 1 and 1A showing a pair of alignment pins located within the outline of the three-dimensional metal object in accordance with another aspect of the present invention shown in top view;

FIG. 3A is a diagrammatic view of the three-dimensional metal object of FIGS. 1 and 1A showing a pair of alignment pins located within the outline of the three-dimensional metal object in accordance with another aspect of the present invention shown in front view;

FIG. 4 is a diagrammatic view of the three-dimensional metal object of FIGS. 1 and 1A showing a pair of alignment pins within tabs external to a rectangular outline of the three-dimensional metal object in accordance with another aspect of the present invention shown in top view;

FIG. 4A is a diagrammatic view of the three-dimensional metal object of FIGS. 1 and 1A showing a pair of alignment pins within tabs external to a rectangular outline of the three-dimensional metal object in accordance with another aspect of the present invention shown in front view;

FIG. 5 is a diagrammatic front view of a three dimensional metal object formed in accordance with another aspect of the present invention showing prefabricated metal elements having preformed non-planar surfaces;

FIG. 6 is a diagrammatic view of the three-dimensional metal object of FIG. 5 showing an enclosed internal cavity in accordance with another aspect of the present invention shown in front view;

FIG. 7 is a diagrammatic view of the three-dimensional metal object of FIGS. 1 and 1A showing prefabricated metal elements having interlocking features in accordance with another aspect of the present invention shown in top view; and

FIG. 7A is a diagrammatic view of the three-dimensional metal object of FIGS. 1 and 1A showing prefabricated metal elements having interlocking features in accordance with another aspect of the present invention shown in front view.

### DETAILED DESCRIPTION OF THE INVENTION

In the following detailed description of the preferred embodiments, reference is made to the accompanying drawings that form a part hereof, and in which is shown by way of illustration, and not by way of limitation, specific preferred embodiments in which the invention may be practiced. It is to be understood that other embodiments may be utilized and that changes may be made without departing from the spirit and scope of the present invention

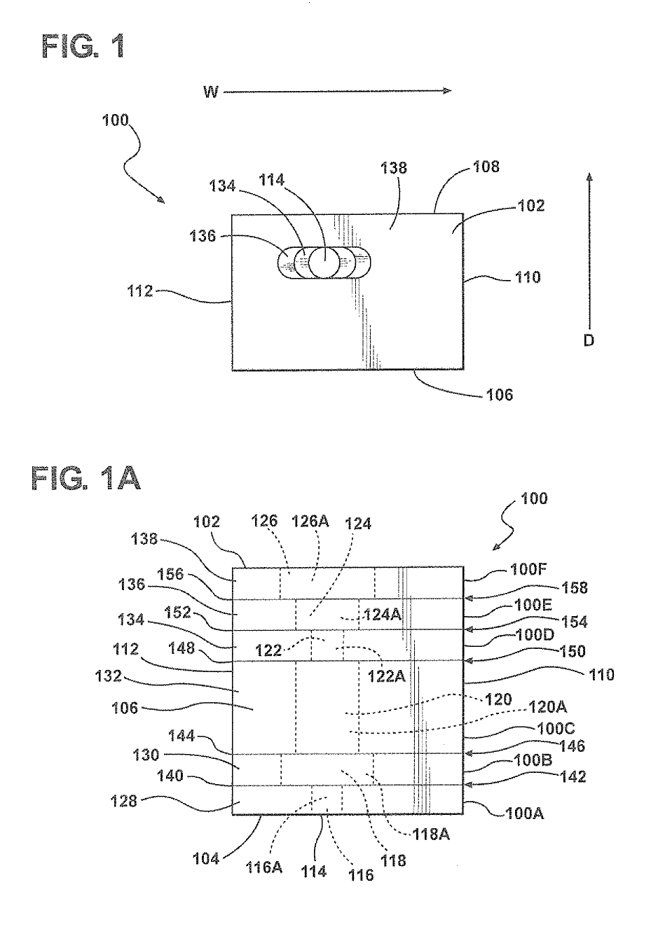

Referring now to the drawings and particularly to FIGS. 1 and 1A, an exemplary metal object 100 formed in accordance with an aspect of the present invention is shown diagrammatically in top and front views. The metal object 100 comprises a rectangular solid object having a top surface 102, a bottom surface 104, a front surface 106, a back surface 108, a right surface 110 and a left surface 112. The metal object 100 may further comprise an elongated aperture 114 extending vertically through the metal object 100 from the top surface 102 to the bottom surface 104. The elongated aperture 114 in the metal object 100 illustrated in FIGS. 1 and 1A comprises a stepped aperture having a bottom first portion 116, a second portion 118, a third portion 120, a fourth portion 122, a fifth portion 124 and a top fifth portion 126.

A plurality of prefabricated metal elements 128, 130, 132, 134, 136 and 138 may be prefabricated into shapes corresponding to adjacent portions of the metal object 100. For example, a first metal element 128 may be prefabricated so as to form a rectangular solid shaped element corresponding to a shape of a lower first portion 100A of the metal object 100. The first metal element 128 may be provided having an aperture 116A therein corresponding to the bottom first portion 116 of the elongated aperture 114 within the metal object 100. In similar fashion, a second metal element 130 corresponding to a second portion 100B of the metal object 100 may be provided having an aperture 118A therein corresponding to the second portion 118 of the elongated aperture 114 within the metal object 100. Likewise, a third metal element 132 corresponding to a third portion 100C of the metal object 100 may be provided having an aperture 120A therein corresponding to the third portion 120 of the elongated aperture 114 within the metal object 100. A fourth metal element 134 corresponding to a fourth portion 100D of the metal object 100 may be provided having an aperture 122A therein corresponding to the fourth portion 122 of the elongated aperture 114 in the metal object 100. Yet a fifth metal element 136 corresponding to a fifth portion 100E of the metal object 100 may be provided having an aperture 124A therein corresponding to a fifth portion 124 of the elongated aperture 114 in the metal object 100. As illustrated in FIGS. 1 and 1A, a sixth metal element 138 corresponding to a shape of a top portion 100F of the metal object 100 may be provided having an aperture 126A therein corresponding to a top portion of the elongated aperture 114 in the metal object 100.

Any suitable fabrication process such as machining, punching, stamping, etc. may be used to prefabricate the metal elements 128, 130, 132, 134, 136 and 138 into shapes corresponding to adjacent portions of the metal object 100. For example, conventional two dimensional machining methods such as machine tool, water jet or laser beam methods may be used to fabricate the metal elements. Moreover, the metal elements may be produced by computer controlled equipment from computer generated data produced in accordance with a computer resident design.

The plurality of prefabricated metal elements 128, 130, 132, 134, 136 and 138 may be assembled in a predetermined arrangement so as to define the metal object 100. As illustrated in FIG. 1A, the prefabricated metal elements 128, 130, 132, 134, 136 and 138 are stacked one atop another in a predetermined sequence such that the metal elements correspond to the successive portions 100A-100F of the metal object 100. A layer of a bonding agent may optionally be applied between adjacent surfaces of adjacent metal elements. The assembled arrangement may subsequently be unit processed such that the metal elements are coupled together into an integral metal object by any suitable means such as, for example, furnace brazing, as will described more fully herein.

As previously mentioned, a bonding agent may be applied between adjacent metal elements during assembly of the object 100. For example, a first layer of bonding agent 140 may be applied at an interface 142 between the first metal element 128 and the second metal element 130. A second layer of bonding agent 144 may be applied at an interface 146 between the second metal element 130 and the third metal element 132. Likewise, a third layer of bonding agent 148 may be applied at an interface 150 between the third metal element 132 and the fourth metal element 134. Yet a fourth layer of bonding agent 152 may be applied at an interface 154 between the fourth metal element 134 and the fifth metal element 136. The exemplary metal object 100 illustrated in FIG. 1A may comprise a fifth layer of bonding agent 156 at an interface 158 between the fifth metal element 136 and the sixth metal element 138.

For purposes of clarity and brevity herein, it will be assumed that the prefabricated metal elements 128, 130, 132, 134, 136 and 138 are made of alloy steel but the principles and concepts of the present invention are not limited to steel materials and other aspects of the invention may comprise metal elements made of any suitable metal such as, for example, brass, aluminum, copper, etc. Furthermore, non-metallic elements may be used in other embodiments of the invention. For example, one or more elements may be made from a transparent material such as glass or plastic in order to provide a visual window into an object made in accordance with another aspect of the invention.

Any suitable bonding agent may be used to bond together the prefabricated metal elements 128, 130, 132, 134, 136 and 138. For example, the prefabricated steel elements illustrated in FIGS. 1 and 1A may be furnace brazed together by applying layers of a braze bonding agent between the adjacent surfaces of the prefabricated steel elements 128, 130, 132, 134, 136 and 138 as previously described. The braze bonding agent may comprise, for example, a braze foil, a braze paste, etc. Alternatively a bonding agent comprising a braze tape may be applied to one or both adjacent surfaces of the prefabricated steel elements 128, 130, 132, 134, 136 and 138 prior to or during the assembly process. For example, the braze tape may be applied to one or both surfaces of a suitable steel plate prior to fabrication of the steel plate into the prefabricated metal elements 128, 130, 132, 134, 136 and 138.

The prefabricated metal elements 128, 130, 132, 134, 136 and 138 may subsequently be unit processed to cure the bonding agent. For example, the braze bonding agent may be cured by placing the assembly in a furnace and heating the assembly to a temperature high enough to melt the braze bonding agent but not high enough to melt the base material of the prefabricated metal elements 128, 130, 132, 134, 136 and 138. In this fashion, the prefabricated metal elements 128, 130, 132, 134, 136 and 138 may be coupled together so as to form an integral metal object 100.

Alternatively, a transient liquid phase (TLP) bonding process may be used to couple the prefabricated metal elements 128, 130, 132, 134, 136 and 138 together. For example, a TLP bonding agent comprising a material of the same composition as the base material of the prefabricated metal elements 128, 130, 132, 134, 136 and 138 may be used. A melting point depressant, for example, boron, may be added to the TLP bonding agent so as to lower the melting point of the bonding agent. Subsequent to assembly of the prefabricated metal elements 128, 130, 132, 134, 136 and 138 with the TLP bonding agent between adjacent surfaces, the assembly may be heated to a temperature high enough to melt the TLP bonding agent but not high enough to melt the base material of the prefabricated metal elements 128, 130, 132, 134, 136 and 138. As the assembly is heated further, the boron diffuses into the base material of the prefabricated metal elements 128, 130, 132, 134, 136 and 138 and the TPL bonding material solidifies coupling the prefabricated metal elements 128, 130, 132, 134, 136 and 138 together. In this fashion, a homogeneous metal object 100 may be formed from the prefabricated metal elements 128, 130, 132, 134, 136 and 138 without the metallurgical discontinuity resulting from the braze bonding previously described.

In accordance with another aspect of the present invention, a metal object 100 may be constructed from a plurality of metal elements having different material properties. For example, a metal object 100 may be constructed from a plurality of metal elements comprising metal elements made from different materials, e.g., steel, brass, aluminum, etc, or from elements made from different alloys of a single material. In this way a heterogeneous metal object 100 may be constructed in which portions of the metal object 100 are made of different metals and/or different alloys in accordance with design parameters of the metal object 100.

In another example, a metal object 100 may be constructed from one or a plurality of first metal elements having a first material property, e.g., a first anisotropic material property or a first coefficient of thermal expansion, and one or a plurality of second metal elements having a second material property that differs from the first material property, e.g., a second anisotropic material property or a second coefficient of thermal expansion. As used in this description and in the appended claims, the term “anisotropic material property” means “directionally dependent material property.”

For example, a plurality of metal elements made from hot or cold rolled steel having different anisotropic material properties corresponding to different rolling directions of the steel may be provided and assembled such that the rolling direction of the individual metal elements varies from element to element in a predetermined anisotropic sequence in accordance with design parameters of the metal object 100. A metal object 100 could be fabricated and assembled such that the rolling direction of the first metal element 128 is oriented in a first direction, e.g., a direction W and the rolling direction of the second metal element 130 is oriented in a second direction, e.g., a direction D, transverse to the direction W, see FIG. 1. In like fashion, the rolling direction of the third 132 and fifth 136 metal elements may be oriented in the direction W and the rolling direction of the fourth 134 and sixth 138 metal elements may be oriented in the direction D. In this fashion, the metal object 100 may comprise a like number of metal elements having the rolling direction oriented in the directions W and D such that a material property, e.g., a tensile strength, corresponding to the rolling direction is equally distributed in the directions W and D. Hence, the tensile strength of the metal object 100 in the direction W is substantially equal to the tensile strength of the metal object 100 in the direction D. In yet a further example, the metal elements could be fabricated and assembled such that the rolling direction of the individual metal elements varies in a progressively changing anisotropic sequence in the metal object 100 so constructed, Furthermore, the rolling directions of the individual metal elements could vary in other ways not explicitly set out herein.

In yet another example, a metal object 100 may be constructed from one or a plurality of first metal elements having a first coefficient of thermal expansion and one or a plurality of second metal elements having a second coefficient of thermal expansion that differs from the first coefficient of thermal expansion. The first and second metal elements may subsequently be assembled in a predetermined arrangement such that the metal object 100 so constructed has a predetermined pattern of coefficients of thermal expansion. For example, one or a plurality of first metal elements and one or a plurality of second metal elements may be fabricated from materials having progressively changing, e.g., progressively increasing, coefficients of thermal expansion and may be assembled in a predetermined arrangement such that the metal object 100 has a progressively increasing coefficient of thermal expansion corresponding to the progressively increasing coefficients of thermal expansion of the metal elements that comprise the metal object 100. In this fashion, a metal object 100 may be constructed that will change shape in a prescribed fashion such as upon increased temperature and return to its original shape upon cooling so long as the yield strength of the metal elements and the shear strength of the bonding material is not exceeded. For example, a metal object 100 constructed of metal elements having progressively increasing coefficients of thermal expansion from a first metal element 128 to a sixth metal element 138 would expand less upon increasing temperature near the bottom surface 104 than near the top surface 102 and would bow upon exposure to increasing temperature forming a concave bottom surface 104 and a convex top surface 102. So long as the yield strength of the metal elements and the shear strength of the bonding material is not exceeded, the metal object 100 will return to its original shape upon cooling.

As an illustrative example, a metal object such as a washer (not shown) may be constructed from one or a plurality of first metal elements having a first coefficient of thermal expansion and one or a plurality of second metal elements having a second coefficient of thermal expansion that is greater than the first coefficient of thermal expansion. The first and second metal elements may be generally planar and assembled in a predetermined arrangement such that the washer is constructed. Upon exposure to increased temperature, the one or more second metal elements may expand more than the one or more first metal elements causing the washer to bow as previously described. As a result, the washer may transform from a flat shape to a shape having a concave first outer surface and a convex opposite outer surface. The washer returns to its original flat shape upon cooling.

In still another example, a metal object (not shown) may be constructed from one or a plurality of first metal elements having a first coefficient of thermal expansion and one or a plurality of second metal elements having a second coefficient of thermal expansion that is greater than the first coefficient of thermal expansion. The first and second metal elements may be assembled in a predetermined arrangement such that the one or more second metal elements define sealing surfaces of the metal object. In this fashion, the metal object may be sized such that it may be assembled into a receiving cavity of another structure at a first temperature. Upon exposure to increased temperature the one or more second metal elements would expand more than the one or more first metal elements creating an interference fit between the one or more second metal elements and cooperating surfaces of the other structure such that the metal object is sealed against the cooperating surfaces of the other structure only at the sealing surfaces defined by the one or more second metal elements. The metal object will return to its original shape upon cooling, and may be readily disassembled from the other structure.

Though the metal object 100 illustrated in FIGS. 1 and 1A comprises six prefabricated metal elements 128, 130, 132, 134, 136 and 138, any number of metal elements corresponding to adjacent portions of the metal object 100 may be provided in other embodiments of the present invention.

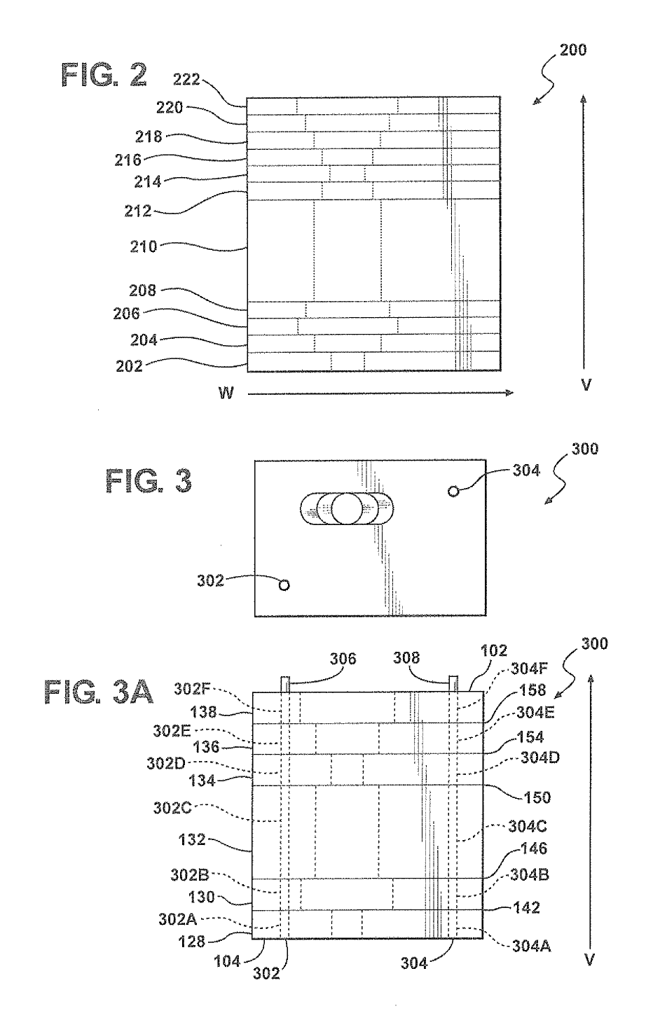

Referring now to FIG. 2, another exemplary metal object 200 constructed in accordance with another aspect of the present invention is shown diagrammatically in front view. The metal object 200 is constructed of 11 metal elements comprising 11 metal laminations, 202, 204, 206, 208, 210, 212, 214, 216, 218, 220 and 222, corresponding to successive sections of the metal object 200. The 11 metal laminations, 202, 204, 206, 208, 210, 212, 214, 216, 218, 220 and 222 are stacked one atop another in a predetermined sequence so as to define the metal object 200.

The exemplary metal object 200 illustrated in FIG. 2 is similar to the metal object 100 illustrated in FIGS. 1 and 1A except that a larger number of metal elements comprising metal laminations each having a smaller dimension in a direction V are used to form the metal object 200. Moreover, changes occurring in the metal object 200 in the directions W and D may be achieved by prefabricating a larger number of metal elements having smaller changes in the direction W and the direction D. In this fashion, more gradual changes occurring in the metal object 200 in the directions W and D may be achieved, and detail of the finished metal object 200 may be improved by providing a larger number of metal elements having a smaller dimension in the direction V each corresponding to a thinner successive adjacent section of the metal object 200.

In yet other embodiments of the present invention, the metal elements used to construct metal objects need not be rectangular-solid or laminar shaped elements as illustrated in FIGS. 1, 1A and 2 but may be any suitable shape corresponding to the shapes of adjacent portions of the metal object to be constructed. For example, cylindrically-shaped metal objects may be constructed from coaxial, cylindrical metal elements corresponding to adjacent, concentric portions of the cylindrical metal object. In like fashion, conical, pyramidal or prismatical metal elements, corresponding to adjacent portions of conical, pyramidal and prismatical metal objects, respectively, may be fabricated and assembled into correspondingly shaped metal objects. Furthermore, adjacent, concentric portions of spheres, ellipsoids and paraboloids may be fabricated and assembled into correspondingly shaped metal objects.

Referring now to FIGS. 3 and 3A, a metal object 300 constructed in accordance with another aspect of the present invention is shown diagrammatically in top and front views. The description with regard to FIGS. 3 and 3A is similar to that described previously with respect to FIGS. 1 and 1A except as set out below and like elements are referred to by like reference numerals. Each of the prefabricated metal elements 128, 130, 132, 134, 136 and 138 comprising the metal object 300 illustrated in FIGS. 3 and 3A has a corresponding first aperture 302A, 302B, 302C, 302D, 302E and 302F, respectively, extending completely through the metal element in a direction V, which is perpendicular to a plane of the top surface 102 of the metal object 300 in the illustrated embodiment. The first aperture 302A, 302B, 302C, 302D, 302E and 302F in each metal element 128, 130, 132, 134, 136 and 138 is positioned so as to be concentric with the corresponding first aperture 302A, 302B, 302C, 302D, 302E and 302F in each other of the metal elements 128, 130, 132, 134, 136 and 138 when the metal elements 128, 130, 132, 134, 136 and 138 are assembled into the predetermined arrangement defining the metal object 300 so as to define a first bore or continuous first aperture 302 extending completely through the metal element 300 in the direction V.

Likewise, each of the prefabricated metal elements 128, 130, 132, 134, 136 and 138 has a corresponding second aperture 304A, 304B, 304C, 304D, 304E and 304F, respectively, extending completely through the metal element in the direction V. The second aperture 304A, 304B, 304C, 304D, 304E and 304F in each metal element 128, 130, 132, 134, 136 and 138 is positioned so as to be concentric with a corresponding second aperture 304A, 304B, 304C, 304D, 304E and 304F in each other of the metal elements 128, 130, 132, 134, 136 and 138 when the metal elements 128, 130, 132, 134, 136 and 138 are assembled into the predetermined arrangement defining the metal object 300 so as to define a second bore or continuous second aperture 304 extending completely through the metal object 300 in the direction V.

A first alignment pin 306 may be positioned in the continuous first aperture 302 so as to extend substantially through each of the metal elements 128, 130, 132, 134, 136 and 138. Likewise a second alignment pin 308 may be positioned in the continuous second aperture 304 so as to extend substantially through each of the metal elements 128, 130, 132, 134, 136 and 138. The first and second alignment pins 306 and 308 may be sized so as to be positioned into the corresponding first and second continuous apertures 302 and 304 such that the metal elements 128, 130, 132, 134, 136 and 138 are registered in proper alignment with respect to each other so as to define the metal object 300. In this fashion, the first and second alignment pins 306 and 308 may serve to maintain the metal elements 128, 130, 132, 134, 136 and 138 in proper position during assembly and processing of the metal object 300.

The first and second alignment pins 306 and 308 may be made from any suitable material such as, for example, alloy steel, and may have a higher melting temperature than the melting temperature of the material from which the metal elements 128, 130, 132, 134, 136 and 138 are made. Additionally, the first and second alignment pins 306 and 308 may serve to improve a shear strength of the metal object 300 in the directions W and D, see FIG. 1, at least at the interfaces 142, 146, 150, 154 and 158 where the metal elements 128, 130, 132, 134, 136 and 138 are coupled together.

As illustrated in FIG. 3, two alignment pins 306 and 308 are positioned near opposite corners of the metal object 300 but any number of such alignment pins may be positioned in any appropriate positions of the metal object 300 in other embodiments of the invention. Furthermore, the alignment pins may be positioned in extensions or tabs extending beyond a defined outline of the metal object 300 as will be described next.

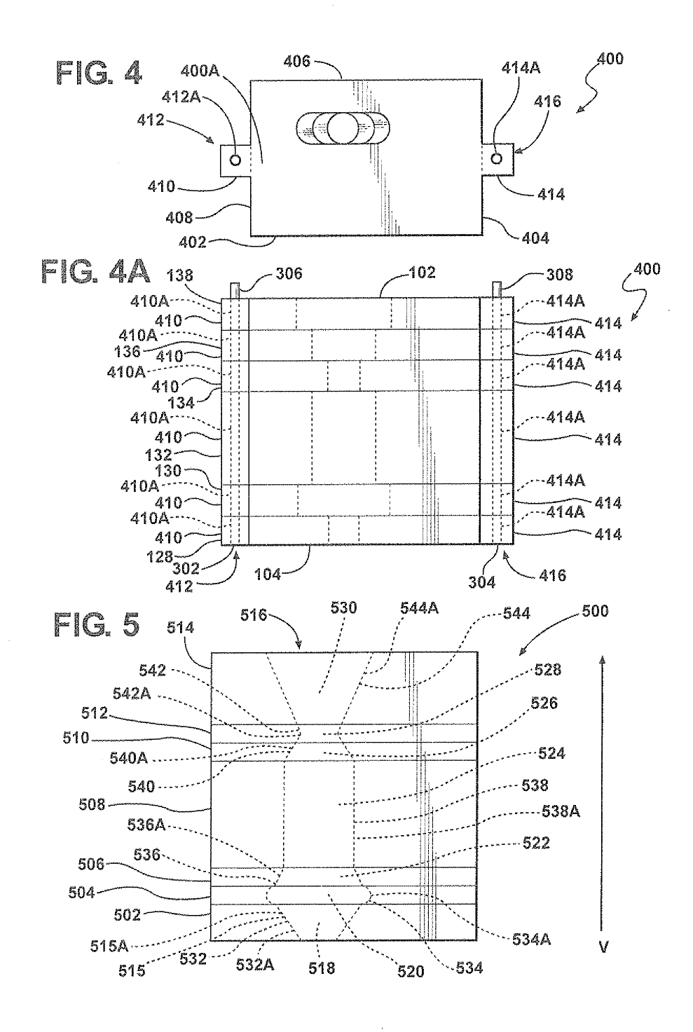

Referring now to FIGS. 4 and 4A, a three dimensional object 400 formed in accordance with another aspect of the present invention is shown diagrammatically in top and front views. The description with regard to FIGS. 4 and 4A is similar to that described previously with respect to FIGS. 1, 1A, 3 and 3A except as set out below and like elements are referred to by like reference numerals. Each of the prefabricated metal elements 128, 130, 132, 134, 136 and 138 comprising the metal object 400 illustrated in FIGS. 4 and 4A has a front side 402, a right side 404, a back side 406 and a left side 408. Extending from the left side 408 of each of the metal elements 128, 130, 132, 134, 136 and 138 is a first rectangular-shaped extension 410. The first extension 410 of each of the metal elements 128, 130, 132, 134, 136 and 138 is positioned to align with a corresponding first extension 410 extending from the left side 408 of each other of the metal elements 128, 130, 132, 134, 136 and 138 forming a solid rectangular-shaped first tab 412 extending from the left side 112, see FIGS. 1 and 4, and beyond a rectangular center portion 400A of the metal object 400 when the metal elements 128, 130, 132, 134, 136 and 138 are assembled into the predetermined arrangement so as to define the metal object 400.

Similarly, a second rectangular-shaped extension 414 extends from the right side 404 of each of the metal elements 128, 130, 132, 134, 136 and 138. The second extension 414 of each of the metal elements 128, 130, 132, 134, 136 and 138 is positioned to align with a corresponding second extension 414 extending from the right side 404 of each other of the metal elements 128, 130, 132, 134, 136 and 138 forming a solid rectangular-shaped second tab 416 extending from the right side 110, see FIG. 1, and beyond the rectangular center portion 400A of the metal object 400 when the metal elements 128, 130, 132, 134, 136 and 138 are assembled into the predetermined arrangement so as to define the metal object 400.

The first and/or second tabs 412 and 416 may provide suitable coupling surfaces for coupling the metal object 400 to another structure by, for example, welding or brazing. By locating the coupling surfaces away from the rectangular center portion 400A of the metal object 400, it may be possible to weld or braze the metal object 400 to such other structure without re-melting the bonding agent within the rectangular center portion 400A used to couple together the metal elements 128, 130, 132, 134, 136 and 138.

One or more alignment pins for aligning the metal elements 128, 130, 132, 134, 136 and 138 as previously described with reference to FIGS. 3 and 3A may optionally be located within a corresponding elongated aperture 412A within the first tab 412 defined by apertures 410A provided in the extensions 410 and/or a corresponding elongated aperture 414A in the second tab 416 defined by apertures 414A provided in the extensions 414. For example, the exemplary metal object 400 illustrated in FIGS. 4 and 4A includes a first alignment pin 306 located within the elongated aperture 412A located in the first tab 412 and a second alignment pin 308 located within the elongated aperture 416A located in the second tab 416. The first and second alignment pins 306 and 308 may maintain the metal elements 128, 130, 132, 134, 136 and 138 in proper position during assembly and processing of the metal object 400. By positioning the alignment pins 306 and 308 within the first and second tabs 412 and 416, the alignment pins 306 and 308 are positioned outside of the rectangular center portion 400A of the metal object 400 so as to avoid interference with features of the metal object 400 within the rectangular center portion 400A. Furthermore, the first and second tabs 412 and 416, including the first and second alignment pins 306 and 308 may optionally be removed from the metal object 400 by, for example, machining, after the metal elements 128, 130, 132, 134, 136 and 138 have been coupled together as previously described.

Though the exemplary metal object 400 illustrated in FIGS. 4 and 4A comprises two rectangular shaped tabs 412 and 416 extending beyond the rectangular outline 400A of the metal object 400, other embodiments of the invention may comprise more or fewer tabs located in any suitable location and having any suitable shape.

Referring now to FIG. 5, another exemplary metal object 500 constructed in accordance with another aspect of the present invention is shown diagrammatically in front view. The description with regard to FIG. 5 is similar to that described previously with respect to FIGS. 1 and 1A except as set out below. As illustrated, the metal object 500 comprises a first prefabricated metal element 502, a second prefabricated metal element 504, a third prefabricated metal element 506, a fourth prefabricated metal element 508, a fifth prefabricated metal element 510, a sixth prefabricated metal element 512 and a seventh prefabricated metal element 514.

The metal elements 502, 504, 506, 508, 510, 512 and 514 may be prefabricated using any suitable method such as, for example, machining, such that one or more includes a preformed non-planar surface 515 defining a corresponding non-planar surface 515A of the finished metal object 500 in accordance with design parameters of the metal object 500. The non planar surface 515A may comprise a non-planar surface on an internal surface of the metal object 500 as illustrated in FIG. 5. Alternatively, the non-planar surface of the metal object 500 may comprise an external surface of the metal object 500.

For example, as illustrated in FIG. 5, the metal object 500 may have an elongated aperture 516 extending through the metal object 500 in the direction V. The first metal element 502 may be fabricated to include a generally conical-shaped aperture 518 extending through the metal element 502 in the direction V defining a lower portion of the elongated aperture 516. The second metal element 504 may include an aperture 520 extending through the metal element 504 in the direction V, defining a second portion of the elongated aperture 516 in the metal object 500. The second metal element 502 may be prefabricated such that the aperture 520 is generally cylindrical and has bowed sides when viewed in cross section as shown in FIG. 5. Likewise the metal elements 506, 508, 510, 512 and 514 may be prefabricated such that each includes an aperture 522, 524, 526, 528 and 530, respectively, forming a corresponding portion of the elongated aperture 516. Each of the metal elements may be prefabricated such that each of the apertures 518, 520, 522, 524, 526, 528 and 530 are concentric with one another when the metal elements 502, 504, 506, 508, 510, 512 and 514 are assembled into the predetermined arrangement so as to define the elongated aperture 516 in the metal object 500.

The first metal element 502 may be prefabricated such that a preformed non-planar surface 532 defines the outline of the generally conical-shaped aperture 518 in the first metal element 502. In this fashion, the preformed non-planar surface 532 defines a corresponding non-planar surface 532A in the metal object 500. In like fashion, the metal elements 504, 506, 508, 510, 512 and 514 may be prefabricated such that each includes at least one preformed non-planar surface 534, 536, 538, 540, 542 and 544 defining at least one corresponding non-planar surface 534A, 536A, 538A, 540A, 542A and 544A of the metal object 500. By prefabricating one or more of the metal elements 502, 504, 506, 508, 510, 512 and 514 so as to include at least one preformed non-planar surface defining a corresponding non-planar surface of the finished metal object 500, the detail of the metal object 500 may be increased without the need to use a larger number of thinner metal elements as may otherwise be required in order to achieve a similar level of detail in the finished metal object 500.

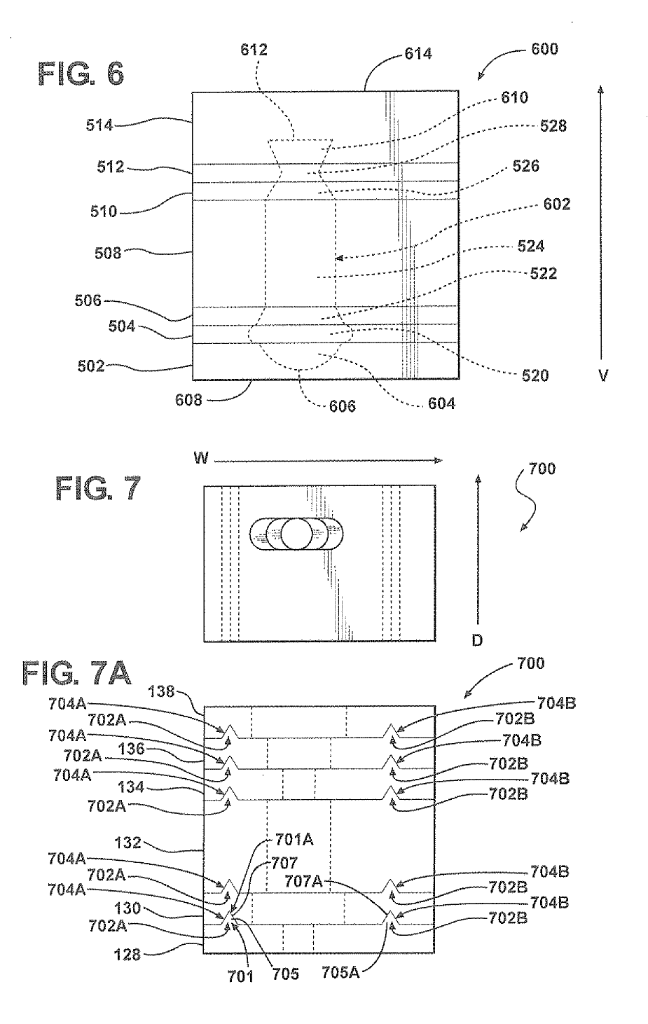

Referring now to FIG. 6, another exemplary metal object 600 constructed in accordance with another aspect of the present invention is shown diagrammatically in front view. The description with regard to FIG. 6 is similar to that described previously with respect to FIGS. 1, 1A and 5 except as set out below and like elements are referred to by like reference numerals. The metal object 600 illustrated in FIG. 6 comprises seven prefabricated metal elements 502, 504, 506, 508, 510, 512 and 514. The metal elements 502, 504, 506, 508, 510, 512 and 514 are prefabricated such that assembly of the metal elements 502, 504, 506, 508, 510, 512 and 514 into the predetermined arrangement as previously described defines at least one enclosed internal cavity 602 within the metal object 600 that does not extend to the exterior of the metal object 600.

For example, each of the metal elements 504, 506, 508, 510 and 512 may be prefabricated so as to include concentric apertures 520, 522, 524, 526 and 528 extending completely through the metal elements 504, 506, 508, 510 and 512 in the direction V. The first metal element 502 may be prefabricated so as to include a cavity 604 that is concentric with the apertures 520, 522, 524, 526 and 528 in the metal elements 504, 506, 508, 510 and 512. The first metal element 502 includes an internal lower surface 606 defining a bottom of the cavity 604. The lower surface 606 may not intersect with an exterior surface 608 of the first metal element 502. In this fashion, the lower internal surface 606 of the first metal element 502 may define a bottom of the enclosed internal cavity 602.

In like fashion, the seventh metal element 514 may be prefabricated so as to include a cavity 610 that is concentric with the apertures 520, 522, 524, 526 and 528 in the metal elements 504, 506, 508, 510 and 512. The cavity 610 in the seventh metal element 514 may have an internal upper surface 612 defining a top of the cavity 610. The upper surface 612 may not intersect with an exterior surface 614 of the seventh metal element 514. In this fashion, the upper surface 612 of the metal element 514 may define a top of the enclosed internal cavity 602.

Once the metal elements 502, 504, 506, 508, 510, 512 and 514 are assembled together in the predetermined arrangement and bonded together as previously described, the apertures 520, 522, 524, 526 and 528 in the metal elements 504, 506, 508, 510 and 512, in conjunction with the cavities 604 and 610 in the first and seventh metal elements 502 and 514, respectively, define the enclosed internal cavity 602 in the metal object 600. As illustrated in FIG. 6, the enclosed internal cavity 602 does not extend to the exterior of the metal object 600.

The exemplary metal object 600 illustrated in FIG. 6 includes a single enclosed internal cavity 602 but the principles and concepts of the present invention may be applied to form other metal objects having a plurality of such enclosed internal cavities. Furthermore, the prefabricated metal elements may be fabricated so as to define a metal object having one or more enclosed internal cavities having any suitable shapes as determined by design parameters of the metal object.

Referring now to FIGS. 7 and 7A, another exemplary metal object 700 constructed in accordance with another aspect of the present invention is shown diagrammatically in top and front views. The description with regard to FIGS. 7 and 7A is similar to that described previously with respect to FIGS. 1 and 1A except as set out below and like elements are referred to by like reference numerals. As illustrated in FIGS. 7 and 7A, the metal object 700 includes a first metal element 128, a second metal element 130, a third metal element 132, a fourth metal element 134, a fifth metal element 136 and a sixth metal element 138. Each of the metal elements 128, 130, 132, 134, 136 and 138 includes at least one interlocking feature 701 configured to cooperate with at least one corresponding interlocking feature 701A of at least one other of the metal elements 128, 130, 132, 134, 136 and 138 so as to interlock the metal elements 128, 130, 132, 134, 136 and 138 together.

For example, as illustrated in FIGS. 7 and 7A, the first metal element 128 includes a first male interlocking feature 702A comprising a first protrusion 705 positioned on a surface adjacent to the second metal element 130 extending in a direction D and a second male interlocking feature 702B comprising a second protrusion 705A positioned on the surface adjacent to the second metal element 130, spaced apart from the first protrusion 705 in the direction W and extending in the direction D.

The second metal element 130 includes a corresponding first female interlocking feature 704A comprising a first channel 707 for receiving the first protrusion 705 of the first metal element 128 positioned on a surface adjacent to the first metal element 128 extending in the direction D and a second female interlocking feature 704B comprising a second channel 707A for receiving the second protrusion 705A of the first metal element 128 positioned on the surface adjacent to the first metal element 128 spaced apart from the first channel 707 in the direction W and extending in the direction D. The second metal element 130 may also include a first male interlocking feature 702A positioned on a surface adjacent to the third metal element 132 extending in the direction D and a second male interlocking feature 702B positioned on the surface adjacent to the third metal element 132 spaced apart from the first male interlocking feature 702A in the direction W and extending in the direction D. The first and second male interlocking features 702A and 702B of the second metal element 132 may be configured to cooperate with corresponding first and second female interlocking features 704A and 704B positioned on a surface of the third metal element 132 adjacent to the second metal element 130.

In like fashion, the third metal element 132, fourth metal element 134 and fifth metal element 136 may include first and second female interlocking features 704A and 704B and first and second male interlocking features 702A and 702B for cooperating with corresponding first and second male interlocking features 702A and 702B and first and second female interlocking features 704A and 704B of an adjacent metal element. The sixth metal element 138 may include first and second female interlocking features 704A and 704B for receiving the first and second male interlocking features 702A and 702B of the fifth metal element 136. In this fashion, at least one of the metal elements 128, 130, 132, 134, 136 and 138 may be interlocked together with at least one other adjacent metal element such that the metal elements 128, 130, 132, 134, 136 and 138 are prevented from moving relative to one another in at least a single direction, for example a direction W.

Interlocking the metal elements 128, 130, 132, 134, 136 and 138 together as previously described may serve to maintain the metal elements 128, 130, 132, 134, 136 and 138 in proper position during assembly and processing of the metal object 700. Additionally, the interlocking features may increase the mechanical integrity of the completed metal object 700 by, for example, by increasing the shear strength of the metal object 700 at the joints between the individual metal elements 128, 130, 132, 134, 136 and 138 at least in the direction W.

As illustrated in FIGS. 7 and 7A, the metal elements 128, 130, 132, 134, 136 and 138 include first and second male interlocking features 702A and 702B for cooperating with corresponding first and second female interlocking features 704A and 704B of an adjacent one of the metal elements 128, 130, 132, 134, 136 and 138 but more or fewer than two interlocking features may be provided for each metal element in other embodiments of the present invention. Moreover, the invention is not limited to interlocking features comprising triangular-shaped protrusions and corresponding triangular-shaped channels extending in a single direction, e.g., the direction D, as illustrated in FIGS. 7 and 7A but interlocking features having any suitable shape and positioned in any suitable positions on one or more of the metal elements 128, 130, 132, 134, 136 and 138 for interlocking adjacent metal elements together may be used. For example, a cylindrically-shaped metal object formed in accordance with another aspect of the present invention may comprise a plurality of cylindrically-shaped concentric metal elements prefabricated such that each such metal element threads into an adjacent metal element. In this fashion, threads prefabricated on the interior and/or exterior surfaces of the concentric metal elements may serve to interlock the metal elements together and increase the mechanical integrity of the finished metal object at least at the interfaces between the individual metal elements.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of forming a three-dimensional metal object comprising:
providing one or more first prefabricated metal elements having shapes corresponding to one or more first portions of a three-dimensional metal object, one of said one or more first prefabricated metal elements having a first material property comprising one of a first anisotropic material property and a first coefficient of thermal expansion;
providing one or more second prefabricated metal elements having shapes corresponding to one or more second portions of said three-dimensional metal object, one of said one or more second prefabricated metal elements having a second material property different from said first material property comprising one of a second anisotropic material property and a second coefficient of thermal expansion;
assembling said one or more first prefabricated metal elements and said one or more second prefabricated metal elements in a predetermined arrangement; and
coupling together said one or more first prefabricated metal elements and said one or more second prefabricated metal elements so as to define the three-dimensional metal object.

2. The method of claim 1, wherein said coupling together said one or more first prefabricated metal elements and said one or more second prefabricated metal elements so as to define the three-dimensional metal object comprises one of brazing together said one or more first prefabricated metal elements and said one or more second prefabricated metal elements and transient liquid phase bonding together said one or more first prefabricated metal elements and said one or more second prefabricated metal elements.

3. The method of claim 1, wherein:
said providing one or more first prefabricated metal elements comprises providing a plurality of first prefabricated metal laminations having shapes corresponding to successive first sections of said three-dimensional metal object;
said providing one or more second prefabricated metal elements comprises providing a plurality of second prefabricated metal laminations having shapes corresponding to successive second sections of said three-dimensional metal object; and
said assembling said one or more first prefabricated metal elements and said one or more second prefabricated metal elements in a predetermined arrangement comprises stacking said plurality of first prefabricated metal laminations and said plurality of second prefabricated metal laminations in a predetermined sequence.

4. The method of claim 1, wherein:
said providing one or more first prefabricated metal elements comprises providing a plurality of first prefabricated metal laminations having a plurality of apertures therein, each of said plurality of apertures in each of said first prefabricated metal laminations being concentric with a corresponding aperture in each other of said first prefabricated metal laminations;
said providing one or more second prefabricated metal elements comprises providing a plurality of second prefabricated metal laminations having a plurality of apertures therein, each of said plurality of apertures in each of said second prefabricated metal laminations being concentric with a corresponding aperture in each other of said second prefabricated metal laminations and each of said first prefabricated metal laminations;
and further comprising:
providing a plurality of alignment pins, said plurality of alignment pins extending through each of said corresponding apertures in each of said first prefabricated metal laminations and said second prefabricated metal laminations such that each of said first prefabricated metal laminations and said second prefabricated metal laminations is aligned with each other of said first prefabricated metal laminations and said second prefabricated metal laminations, wherein said plurality of alignment pins increases a shear strength of said three-dimensional metal object.

5. The method of claim 3, wherein said stacking said plurality of first prefabricated metal laminations and said plurality of second prefabricated metal laminations in a predetermined sequence comprises stacking said plurality of first prefabricated metal laminations and said plurality of second prefabricated metal laminations in a predetermined anisotropic sequence.

6. The method of claim 1, wherein:
said providing one or more first prefabricated metal elements comprises providing a plurality of first prefabricated metal laminations having progressively changing coefficients of thermal expansion;
said providing one or more second prefabricated metal elements comprises providing a plurality of second prefabricated metal laminations having progressively changing coefficients of thermal expansion; and
said coupling together said one or more first prefabricated metal elements and said one or more second prefabricated metal elements comprises coupling together said plurality of first prefabricated metal laminations and said plurality of second prefabricated metal laminations so as to define said three-dimensional metal object having a progressively changing coefficient of thermal expansion.

7. A method of forming a three-dimensional metal object comprising:
providing a plurality of prefabricated metal elements having shapes corresponding to adjacent portions of a three-dimensional metal object, at least one of said plurality of prefabricated metal elements having at least one preformed non-planar surface;
assembling said plurality of prefabricated metal elements in a predetermined arrangement; and
coupling together said plurality of prefabricated metal elements so as to define the three-dimensional metal object, wherein said at least one preformed non-planar surface of said at least one prefabricated metal element defines at least one corresponding non-planar surface of the three-dimensional metal object.

8. The method of claim 7, wherein said assembling said plurality of prefabricated metal elements in a predetermined arrangement comprises assembling said plurality of prefabricated metal elements in a predetermined arrangement having at least one enclosed internal cavity.

9. The method of claim 7, wherein said coupling together said plurality of prefabricated metal elements so as to define the three-dimensional metal object comprises transient liquid phase bonding together said plurality of prefabricated metal elements forming a homogeneous three-dimensional metal object.

10. The method of claim 7, wherein said coupling together said plurality of prefabricated metal elements so as to define the three-dimensional metal object comprises brazing together said plurality of prefabricated metal elements.

11. The method of claim 7, wherein:
said providing a plurality of prefabricated metal elements having shapes corresponding to adjacent portions of a three-dimensional metal object comprises providing a plurality of prefabricated metal laminations having shapes corresponding to successive sections of said three-dimensional metal object; and
said assembling said plurality of said prefabricated metal elements in a predetermined arrangement further comprises stacking said plurality of said prefabricated metal laminations in a predetermined sequence.

12. The method of claim 11, wherein:
said providing a plurality of prefabricated metal laminations comprises providing a plurality of prefabricated metal laminations having a plurality of apertures therein, each of said plurality of apertures in each of said plurality of prefabricated metal laminations being concentric with a corresponding aperture in each other of said plurality of prefabricated metal laminations;
and further comprising:
providing a plurality of alignment pins, each of said plurality of alignment pins extending through each corresponding aperture in each of said plurality of prefabricated metal laminations such that each of said plurality of prefabricated metal laminations is aligned with each other of said plurality of prefabricated metal laminations, wherein said plurality of alignment pins increases a shear strength of said three-dimensional metal object.

13. A method of forming a three-dimensional metal object comprising:
providing a plurality of prefabricated metal elements having shapes corresponding to adjacent portions of a three-dimensional metal object, at least one of said plurality of prefabricated metal elements having at least one interlocking feature configured to cooperate with at least one corresponding interlocking feature of at least one other of said plurality of prefabricated metal elements; and
assembling said plurality of prefabricated metal elements in a predetermined arrangement, wherein said interlocking feature of said one of said plurality of prefabricated metal elements cooperates with said one corresponding interlocking feature of another adjacent prefabricated metal element so as to interlock said one and another prefabricated metal elements together; and
coupling together said plurality of prefabricated metal elements so as to define the three-dimensional metal object.

14. The method of claim 13, wherein said coupling together said plurality of prefabricated metal elements comprises brazing together said plurality of prefabricated metal elements.

15. The method of claim 13, wherein said coupling together said plurality of prefabricated metal elements comprises transient liquid phase bonding together said plurality of prefabricated metal elements forming a homogeneous three-dimensional metal object.

16. The method of claim 13, wherein:
said providing a plurality of prefabricated metal elements having shapes corresponding to adjacent portions of a three-dimensional metal object comprises providing a plurality of prefabricated metal laminations having shapes corresponding to successive sections of a three-dimensional metal object; and
said assembling said plurality of prefabricated metal elements in a predetermined arrangement comprises stacking said plurality of prefabricated metal laminations in a predetermined sequence.

17. The method of claim 16, wherein:
said providing a plurality of prefabricated metal laminations comprises providing a plurality of prefabricated metal laminations having an anisotropic material property; and
said stacking said plurality of prefabricated metal laminations in a predetermined sequence comprises stacking said plurality of prefabricated metal laminations in a predetermined anisotropic sequence.

18. The method of claim 16, wherein:
said providing a plurality of prefabricated metal laminations comprises providing a plurality of prefabricated metal laminations having a plurality of apertures therein, each of said plurality of apertures in each of said plurality of prefabricated metal laminations being concentric with a corresponding aperture in each other of said plurality of prefabricated metal laminations;
and further comprising:
providing a plurality of alignment pins for aligning said plurality of prefabricated metal laminations, wherein each of said plurality of alignment pins extends through each corresponding aperture in each of said plurality of prefabricated metal laminations so as to increase a shear strength of said three-dimensional metal object.

19. The method of claim 16, wherein said providing a plurality of prefabricated metal laminations having shapes corresponding to successive sections of a three-dimensional metal object comprises providing a plurality of prefabricated metal laminations having at least one extension extending beyond an outline of said three-dimensional metal object, wherein each of said extensions of said plurality of three-dimensional metal laminations corresponds with each other of said extensions of said plurality of prefabricated metal laminations defining a tab on said three-dimensional metal object, said tab extending beyond an outline of said three-dimensional metal object.
